(19) United States
(12) Patent Application Publication
(10) Pub. No.: US 2015/0082834 A1
(43) Pub. Date: Mar. 26, 2015

(54) METHOD AND APPARATUS FOR TEMPERING GLASS SHEETS

(71) Applicant: Glaston Finland Oy, Tampere (FI)

(72) Inventors: Jukka VEHMAS, Tampere (FI); Tarmo PESONEN, Lempaala (FI)

(73) Assignee: Glaston Finland Oy, Tampere (FI)

(21) Appl. No.: 14/496,311

(22) Filed: Sep. 25, 2014

(30) Foreign Application Priority Data
Sep. 25, 2013 (FI) 20135958

(51) Int. Cl. C03B 27/044; C03B 27/04

(52) U.S. Cl. CPC C03B 27/044; C03B 27/0404
USPC 65/35; 65/351

(57) ABSTRACT

A method and apparatus for tempering glass sheets. The glass sheets are heated to a tempering temperature in a furnace, in which the glass sheets are moved back and forth while supported upon rolls. The heated glass sheets are fed into a quench unit which is divided into two quenching zones with separately controlled blasting pressures. The glass sheets are driven without stopping through the first quenching zone into the second quenching zone, in which the glass is moved back forth upon the rolls. In the first quenching zone, cooling air is blasted onto glass sheet surfaces with slit nozzles. In the second quenching zone, cooling air is blasted onto glass sheet surfaces with hole-type nozzles.

The invention relates to a method for tempering glass sheets, said method comprising heating the glass sheets to a tempering temperature in a furnace in which the glass sheet is moved back and forth while supported on rolls, and feeding the heated glass sheets into a quench unit which is divided into two quenching zones with separately controlled blasting pressures.

The invention relates also to an apparatus for tempering glass sheets, said apparatus comprising a furnace, rolls in the furnace which are rotated back and forth for moving the glass sheets back and forth, a quench unit including a first and a second quenching zone, first cooling air boxes with their nozzles in the first quenching zone, second cooling air boxes with their nozzles in the second quenching zone, means for conducting the cooling air separately into the first and second cooling air boxes, and conveyor rolls in the quenching zones.

Tempering furnaces for glass sheets, in which the glass sheets are oscillated both in a heating furnace and in a quench unit, have been generally known and in use for several decades.

One of the major problems in furnaces of this type is anisotropy developing in glass, i.e. an uneven distribution of chilling effect across the glass surface area. This leads to small density variations in glass, as a consequence of which the reflection and transmission properties of glass are different in various regions, which can be seen as disturbing patterns in certain lighting conditions. The cooling jets of a chiller are visible as separate stripes and a sparse cord wrapping of the roll is seen as a zigzag pattern. The anisotropy problem is particularly related to the initial stage of cooling, since anisotropy is no longer developed once the glass temperate is below 470° C. The tempering temperature, to which the glass is heated in the furnace, is approximately 630° C.

It is an objective of the invention to provide a method and apparatus of the foregoing type, which are capable of minimizing the anisotropy problem without substantially increasing the costs of a traditional tempering furnace.

This objective is attained by a method of the invention on the basis of characterizing features presented in the appended claim 1. This objective is also attained by an apparatus of the invention on the basis of characterizing features presented in the appended claim 6. Preferred embodiments of the invention are presented in the dependent claims.

One exemplary embodiment of the invention will now be described more closely with reference to the accompanying drawings, in which

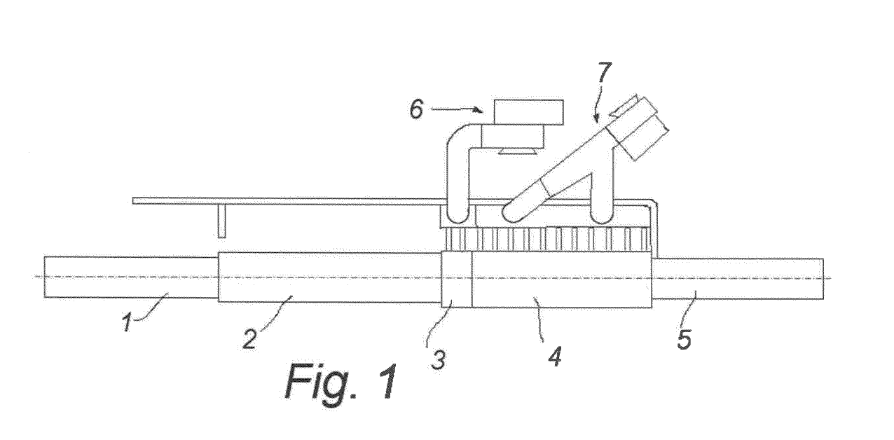

FIG. 1 shows in a schematic plan view an apparatus for use in implementing a method of the invention.

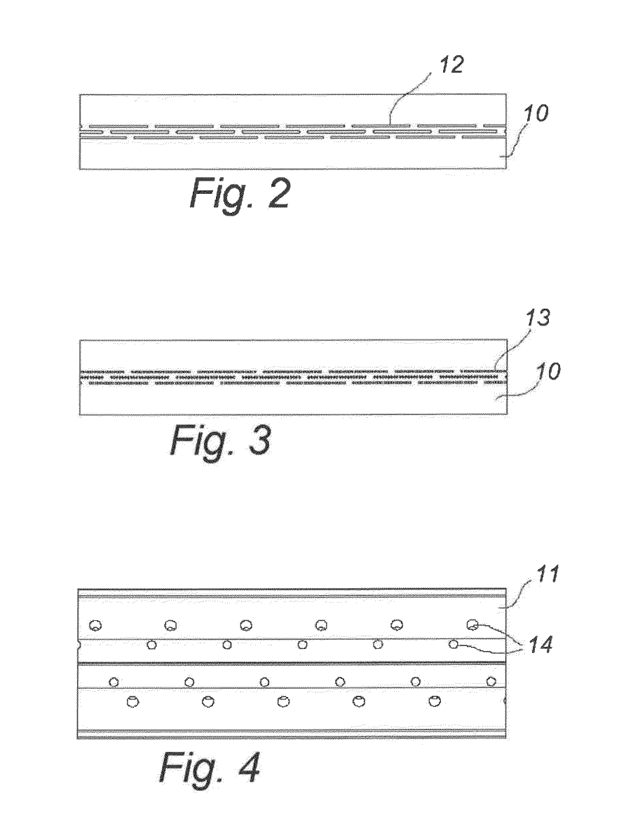

FIG. 2 shows a short segment of the cover for a cooling air box used in a first quenching zone 3.

FIG. 3 shows the same as FIG. 2, but with an alternatively designed slit nozzle.

FIG. 4 shows a short segment of the cover for a cooling air box used in a second quenching zone 4.

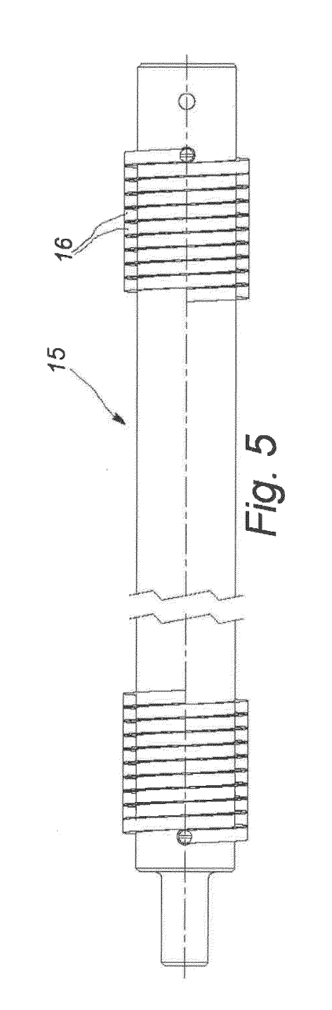

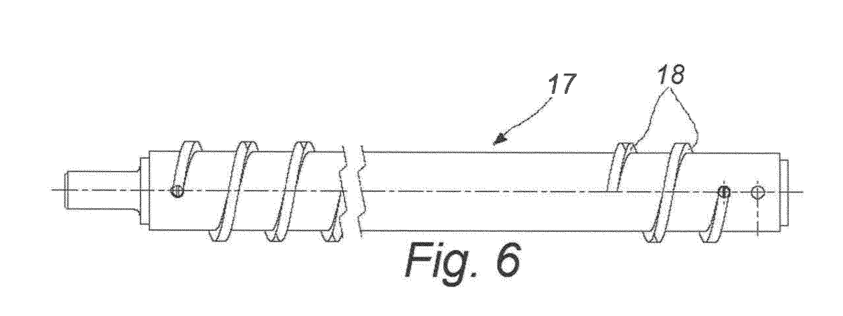

FIG. 5 shows a conveyor roll used in the first quenching zone 3, and

FIG. 6 shows a conveyor roll used in the second quenching zone 4.

The apparatus shown in FIG. 1 comprises a feed conveyor 1, a heating furnace 2, a quench unit with a first quenching zone 3 and a second quenching zone 4, as well as an unloading conveyor 5. A blower mechanism 6 is used for pressurizing the cooling air to be blasted into the first quenching zone 3. A blower mechanism 7 is used for pressurizing the cooling air to be blasted into the second quenching zone 4. The separate blower mechanisms enable blasting pressures of the quenching zones 3 and 4 to be controlled separately.

In the furnace 2, glass sheets are moved back and forth upon rolls, which are rotated back and forth. The rolls can be ceramic. The heated glass sheets are driven from the furnace 2 without stopping through the first quenching zone 3 into the second quenching zone 4. The glass sheets have a dwell time in the quenching zone 3 of at least 20 seconds, preferably at least 30 seconds, typically e.g. about 40 seconds. In the second quenching zone 4, the glass sheet is moved back and forth upon rolls 17 with a sparse cord wrapping 18. In the first quenching zone 3, on the other hand, the glass sheets are carried on rolls 15 with a full cord wrapping by cords 16, thus providing a uniform thermal conduction effect from the rolls.

Another essential feature in the invention is that, in the first quenching zone 3, cooling air is blasted onto the opposite surfaces of a glass sheet with slit nozzles 10 (FIGS. 2 and 3) whose orifices 12, 13 are long slits transverse to the traveling direction of glass sheets. Hence, the blasting effect is regionally uniform and consistent. In the exemplary embodiment of FIG. 2, the slits 12 have a length several tenfold more than the width thereof, and webs between the slits are about 1/10 of the length of the slits. Accordingly, in a nozzle cover constructed e.g. with three rows of slits, there are two nozzle slits at each web in the traveling direction of glass sheets. Hence, the webs do not produce anisotropy-creating stripes on the surface of a glass sheet. A more or less similar result is obtained with the slit nozzle solution of FIG. 3, wherein the slit nozzle 13 is constructed with an array of densely drilled holes, in which the web between the holes does not exceed the diameter of the hole. Thus, the air jets emerging through the holes join each other to make up a homogeneous wide jet.

In the second quenching zone 4, the nozzles 14 of cooling air boxes 11 are hole-type nozzles, the holes being circular and the holes making up rows transverse to the conveying direction with a distance between the holes being multifold as compared to the diameter of the holes. Thus, the holes do not produce a slit effect. However, this has no longer a substantial significance in terms of the anisotropy problem as the glass sheet has already chilled adequately in the quenching zone 3 (preferably to below 470° C.), such that anisotropy (stripes in the glass traveling direction) is not created any more.

Neither do the fully cord wrapped rolls 15 in the zone 3 produce a zigzag anisotropy pattern. In the section 4, this hazard no longer exists even though the rolls 17 are provided with just a sparse cord wrapping.

It is observed that the combination according to the invention enables an essential problem to be eliminated in a cost effective manner. The more costly nozzles and rolls are only needed in a small section of the quench unit 3, 4. The quench unit has a size for example in the order of 3+15,6 m, whereby a portion of the more expensive quenching zone 3 is less than ⅕ of the length of the entire quench unit. When implementing the invention, the lengths of the zones 3 and 4 have a ratio of no more than ⅓, preferably no more than ¼, and typically the aforesaid slightly less than ⅕.

The slit nozzles 12, 13 and the hole-type nozzles 14 provide different heat transfer coefficients, even with an equal cross-sectional area of the hole and with an equal blasting pressure. This is why the blasting pressure of the slit nozzles 12, 13 must be controlled separately with respect to the blasting pressure of the hole-type nozzles 14. In addition, blasting distances for the nozzles 12, 13, 14 of the first and second quenching zones are controlled independently in each zone 3, 4. Thus, the first and second quenching zones 3, 4 are totally separate from each other by being different structurally, functionally and in terms of adjustments and by being separately controlled.

1. A method for tempering glass sheets, said method comprising:
heating the glass sheets to a tempering temperature in a furnace in which the glass sheets are moved back and forth while supported on rolls, and
feeding the heated glass sheets into a quench unit which is divided into two quenching zones with separately controlled blasting pressures,
wherein the glass sheets are driven without stopping through the first quenching zone into the second quenching zone in which the glass sheet is moved back and forth upon the rolls, and
wherein the first quenching zone cooling air is blasted onto glass sheet surfaces with slit nozzles.

2. A method according to claim 1, wherein in the second quenching zone cooling air is blasted onto glass sheet surfaces with hole-type nozzles.

3. A method according to claim 1, wherein in the first quenching zone a glass sheet is conveyed upon fully cord wrapped rolls and in the second quenching zone a glass sheet is conveyed upon sparsely cord wrapped rolls.

4. A method according to claim 1, wherein each of the glass sheets stays in the first quenching zone for at least 20 seconds.

5. A method according to claim 2, wherein blasting distances of the first and second quenching zones' nozzles are controlled independently in each zone.

6. An apparatus for tempering glass sheets, said apparatus comprising:
a furnace,
rolls in the furnace which are configured to be rotated back and forth for moving the glass sheets back and forth,
a quench unit including a first and a second quenching zone,
first cooling air boxes with their nozzles in the first quenching zone, second cooling air boxes with their nozzles in the second quenching zone, means for conducting the cooling air separately into the first and second cooling air boxes, and
conveyor rolls in the quenching zones,
wherein the nozzles of the first cooling air boxes are slit nozzles and the rolls of the first quenching zone are adapted to be rotated continuously in one direction and the rolls of the second quenching zone are adapted to be rotated back and forth.

7. An apparatus according to claim 6, wherein the nozzles of the second cooling air boxes are hole-type nozzles, the holes being circular.

8. An apparatus according to claim 6, wherein the rolls of the first quenching zone are fully wrapped with cord and the rolls of the second quenching zone are sparsely wrapped with cord.

9. An apparatus according to claim 6, wherein the glass sheets have a dwell time in the first quenching zone of at least 20 seconds.

10. An apparatus according to claim 6, wherein the slit nozzle is constructed with an array of densely drilled holes, wherein the web between the holes does not exceed the diameter of the holes.

11. An apparatus according to claim 6, wherein blasting distances for the nozzles of the first and second quenching zones' are independently controllable both above and below the glass sheet.
